(19) United States
(12) Patent Application Publication
(10) Pub. No.: US 2004/0166872 A1
(43) Pub. Date: Aug. 26, 2004

(54) Eyes and ears of America

(76) Inventor: Robert B. Martinez, Roy, UT (US)

Correspondence Address: Robert B Martinez, 2961 W 4475 S, ROY, UT, 84067, US

(21) Appl. No.: 10/371,112

(22) Filed: Feb. 24, 2003

(51) Int. Cl. H04Q 7/20

(52) U.S. Cl. 455/456.1; 455/456.3

(57) ABSTRACT

I believe that this idea is new because radio and cell phones are being implemented Together. They can be used to warn the public as to what they want to hear.

### SPECIFICATIONS

Enclosed is my idea for eyes and ears of America.

My idea is to use public

Exposure in the form of radio to inform the public when a high speed Pursuit is in effect it can also be used when a child is missing. Thru the use of radio We alert the public as to what is happening and they in turn using their cell phones Alert the police.

1. I claim EYES AND EARS OF AMERICA to be my sole invention Its use is to bring public broadcasting in the form of radio to the Public in case of a high speed pursuit and a child abduction
